(19) United States
(12) Patent Application Publication
(10) Pub. No.: US 2021/0185416 A1
(43) Pub. Date: Jun. 17, 2021

(54) TELECOMMUNICATIONS EQUIPMENT CABINET

(71) Applicant: COMMSCOPE CONNECTIVITY BELGIUM BVBA, Kessel-Lo (BE)

(72) Inventors: Jiri ZAVREL, Wilsele (BE); Rob VAN DIJK, Oosterhout (NL); Bart VAN MEEUWEN, Zonhoven (BE)

(21) Appl. No.: 17/187,229

(22) Filed: Feb. 26, 2021

Related U.S. Application Data
(63) Continuation of application No. PCT/EP2019/073287, filed on Aug. 30, 2019.
(60) Provisional application No. 62/725,916, filed on Aug. 31, 2018.

(51) Int. Cl. H04Q 1/02; H04Q 1/06; G02B 6/44

(52) U.S. Cl. CPC H04Q 1/025; G02B 6/4459; H04Q 1/066; H04Q 1/062

(57) ABSTRACT

A telecommunications equipment cabinet including an equipment zone, and a cable storage zone including a plurality of panels and radius limiters for guiding a technician for proper cable routing. A splitter zone for managing fiber optic splitters used in connection with the equipment positioned in the equipment zone. Cables extending to and from the splitters can be managed by the cable storage zone. The cabinet can include two equipment zones spaced apart by the cable storage zone. One of the equipment zones can also be combined with a splitter zone for holding fiber optic splitters, or the equipment zone can be used with patch cables.

### CROSS-REFERENCE TO RELATED APPLICATION

This application is a Continuation of PCT/EP2019/073287, filed on Aug. 30, 2019, which claims the benefit of U.S. Patent Application Ser. No. 62/725,916, filed on Aug. 31, 2018, the disclosure of which is incorporated herein by reference in its entirety. To the extent appropriate, a claim of priority is made to each of the above disclosed applications.

### BACKGROUND OF THE INVENTION

Telecommunications equipment cabinets are known for holding equipment and managing telecommunications cables extending to and from the equipment. One common concern with telecommunications equipment cabinets is ease of managing the cables so as to avoid a cable mess or tangle when adding or removing cables is difficult. Another common concern is compact size for space savings, without compromising the ease of cable and equipment access. Improvements are desired.

### SUMMARY OF THE INVENTION

One aspect of the present invention relates to a telecommunications equipment cabinet including an equipment zone, and a cable management or cable storage zone including a plurality of panels and radius limiters for guiding a technician for proper cable routing.

Another aspect of the present invention includes a splitter zone for managing fiber optic splitters used in connection with the equipment positioned in the equipment zone. Cables extending to and from the splitters can be managed by the cable storage zone.

In a further aspect of the present invention, the cabinet can include two equipment zones spaced apart by a cable storage zone. In one embodiment, one of the equipment zones can also be combined with a splitter zone for holding fiber optic splitters. The storage zone manages the splitter pigtails.

In another aspect of the present invention, the cabinet can include two equipment zones spaced apart by a cable storage zone. In one embodiment, the equipment and/or the equipment zones can connected with patch cords in a cross-connect application.

### BRIEF DESCRIPTION OF THE DRAWINGS

FIG. 1 is a front perspective view of a first embodiment of a telecommunications equipment cabinet, shown empty without equipment, splitters, or cables;

FIG. 2 is a further front perspective view of the telecommunications equipment cabinet of FIG. 1;

FIG. 3 is a front view of telecommunications equipment cabinet of FIG. 1;

FIG. 4 shows the telecommunications cabinet of FIGS. 1-3 including telecommunications equipment, fiber optic splitters, and cables connecting to the equipment and the fiber optic splitters;

FIG. 5 is an enlarged view of the equipment zone, and the splitter zone of the cabinet of FIG. 4;

FIG. 6 is an enlarged view of the cable storage zone of the cabinet of FIG. 4;

FIG. 7 shows a second equipment zone and cables extending to and from the splitter zone of FIG. 4;

FIG. 8 is an enlarged view of a portion of the second equipment zone of the cabinet of FIG. 4 showing a connector storage zone;

FIG. 9 is a similar view for the views of FIGS. 4-8 showing telecommunications equipment without front covers, and no connector storage zone in the second equipment zone;

FIG. 10 is an enlarged view of the cable storage zone of the cabinet of FIG. 9, including a further view of the equipment in the equipment zone; and

FIGS. 11A-D show various cable routing pathways for storage of the cabling extending to and from the equipment in one example embodiment;

FIG. 12 is a front perspective view of a second embodiment of a telecommunications equipment cabinet, shown with equipment and splitters;

FIG. 13 is a further front perspective view of the telecommunications equipment cabinet of FIG. 12;

FIG. 14 is a front view of telecommunications equipment cabinet of FIG. 12;

FIG. 15 is an enlarged view of the cable storage zone of the cabinet of FIG. 12.

### DETAILED DESCRIPTION OF THE PREFERRED EMBODIMENTS

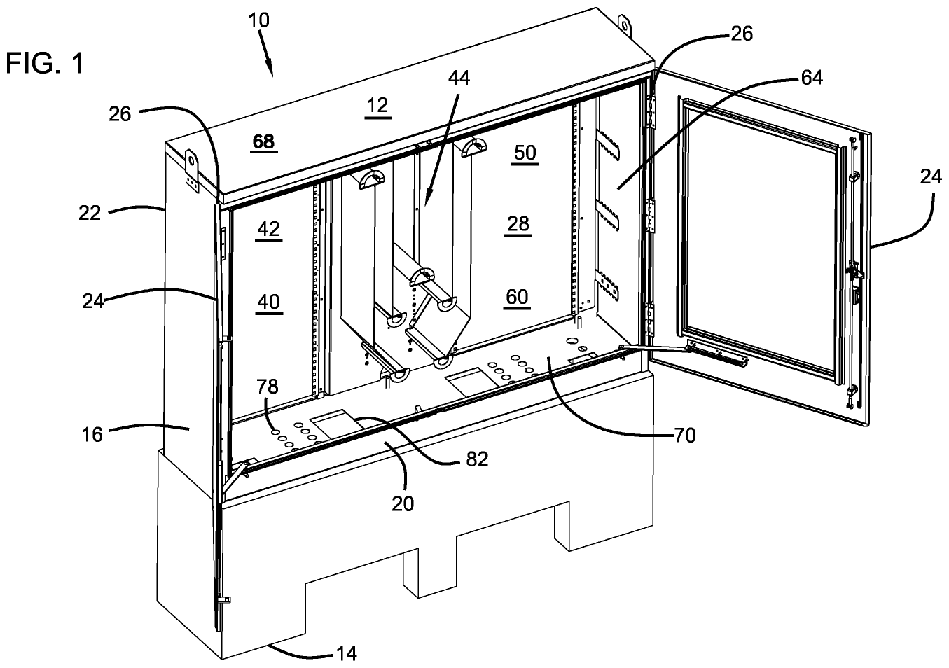

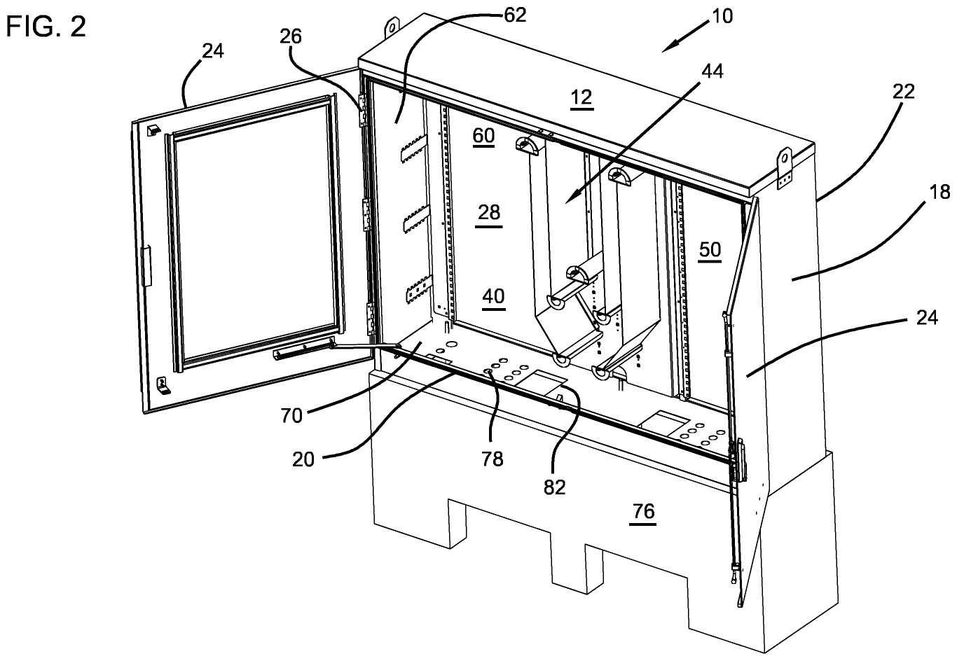

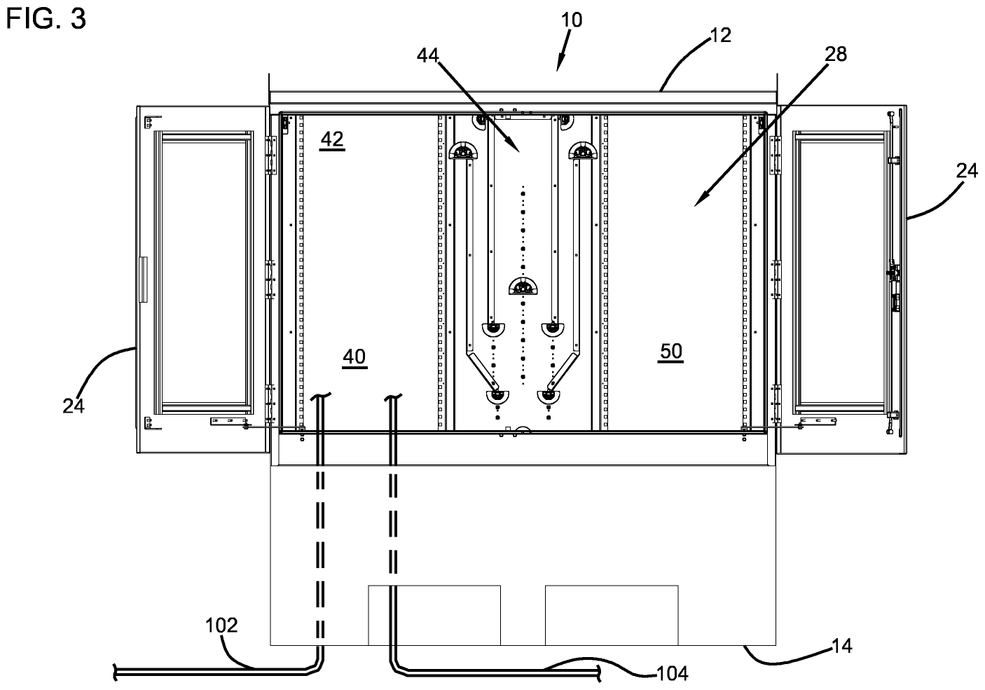

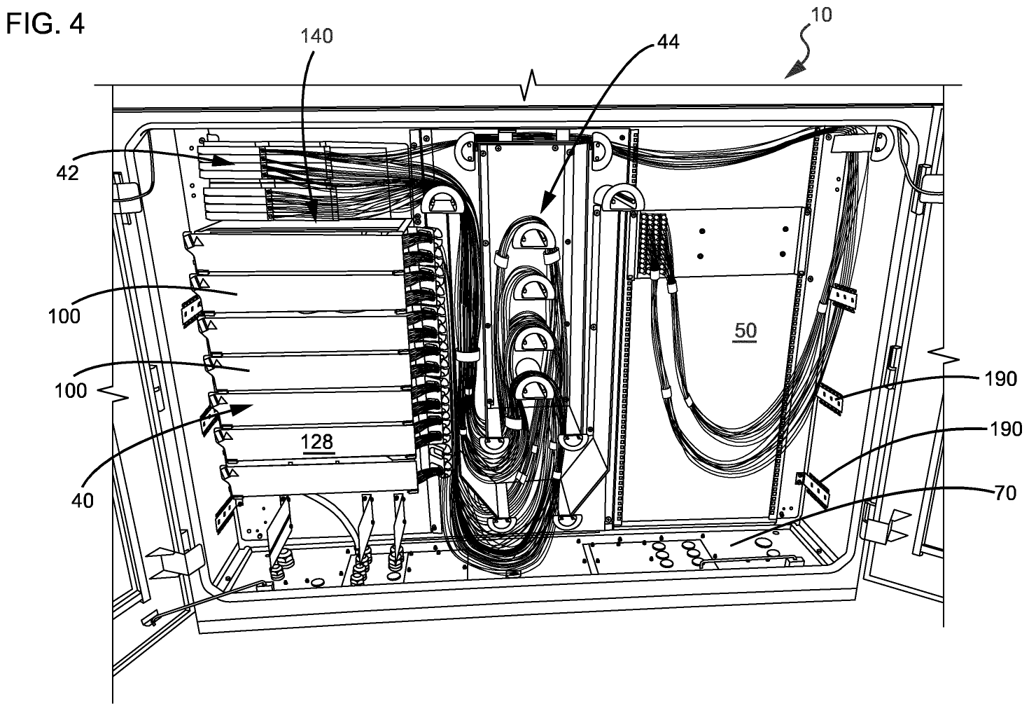

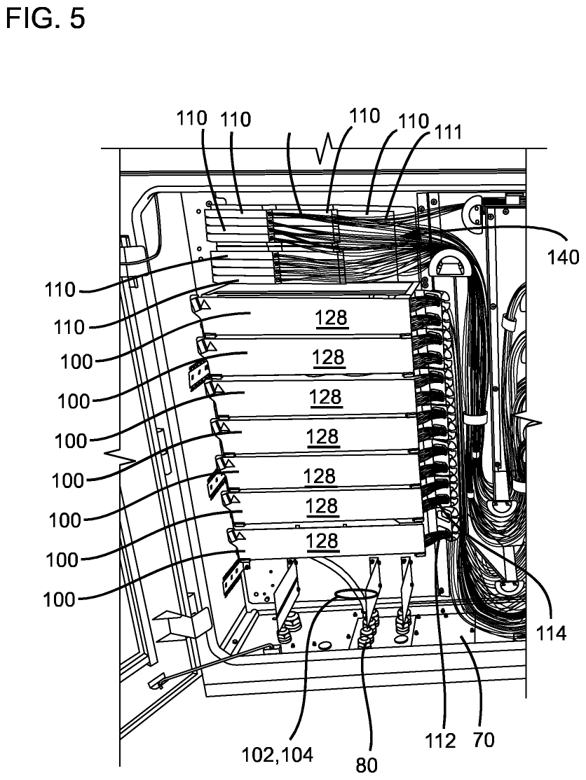

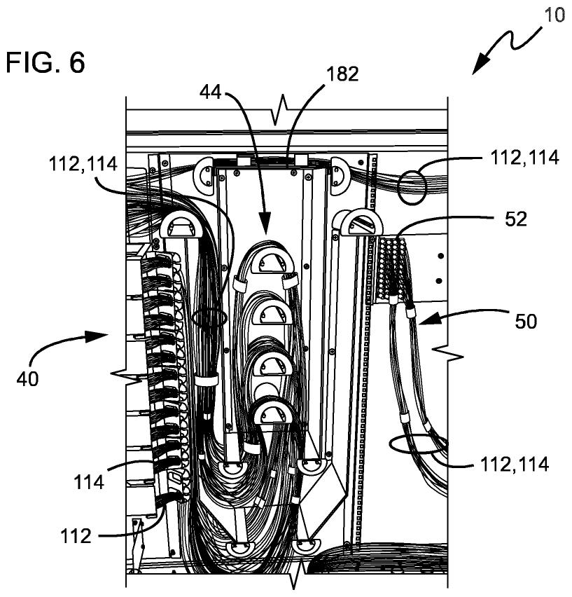

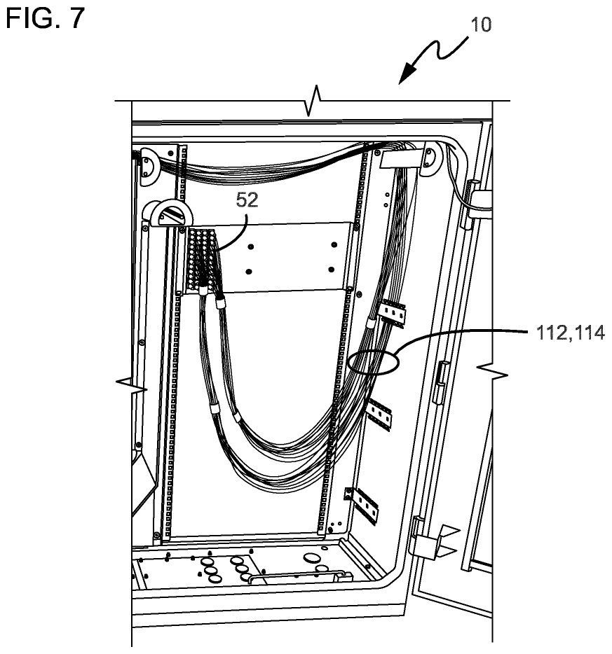

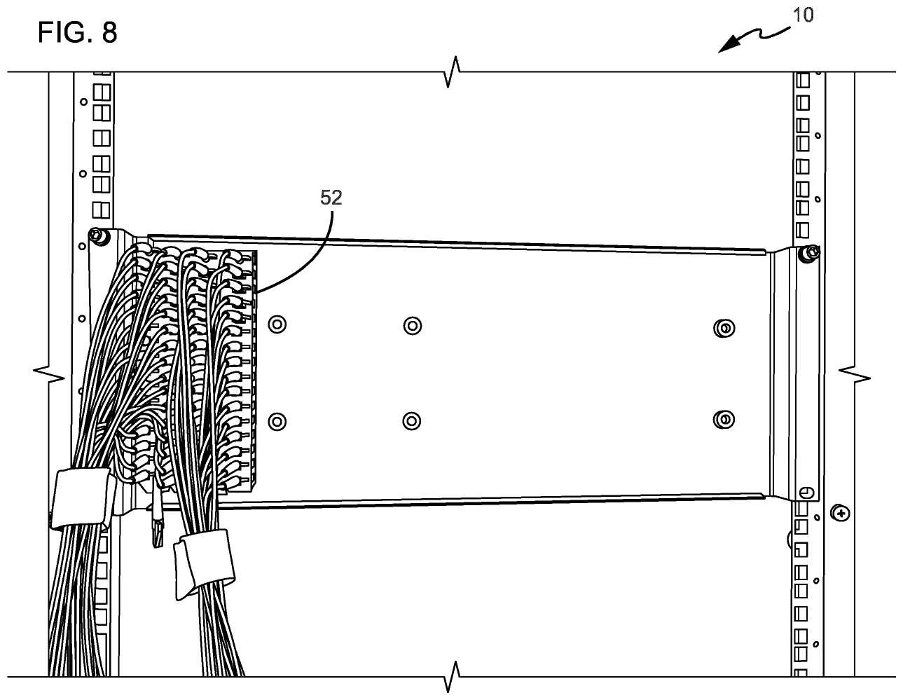

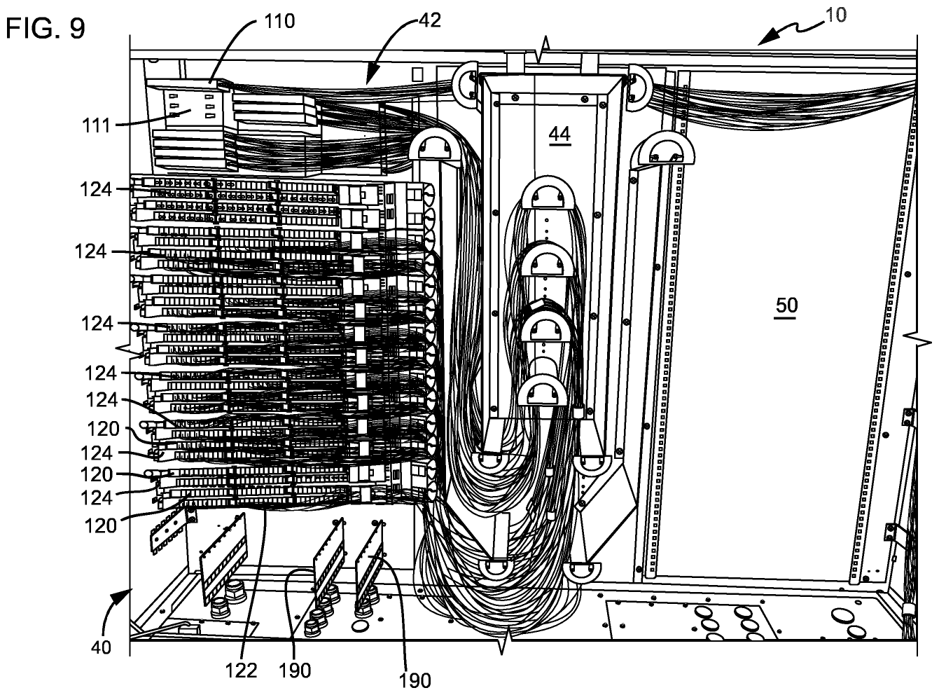

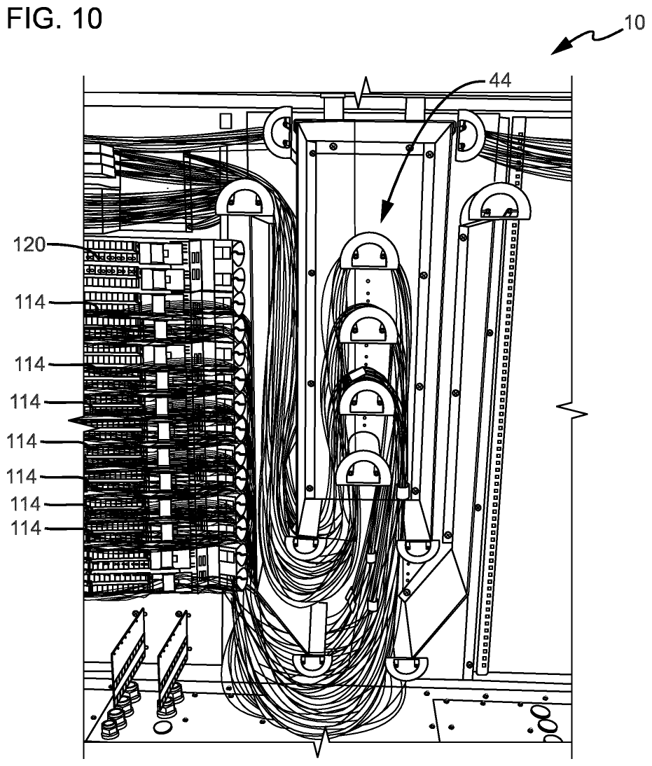

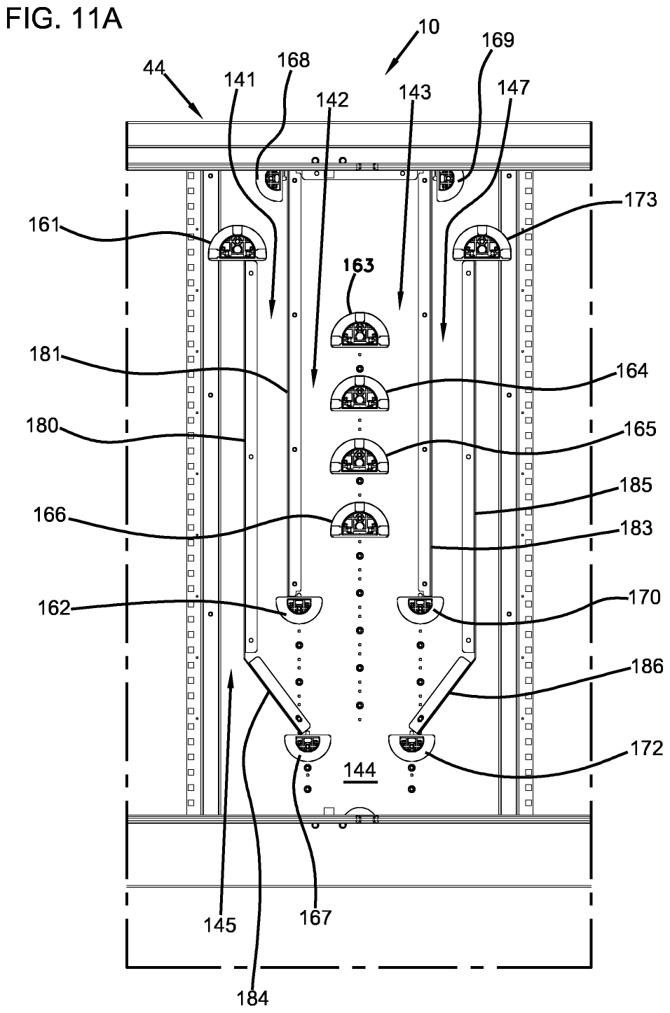

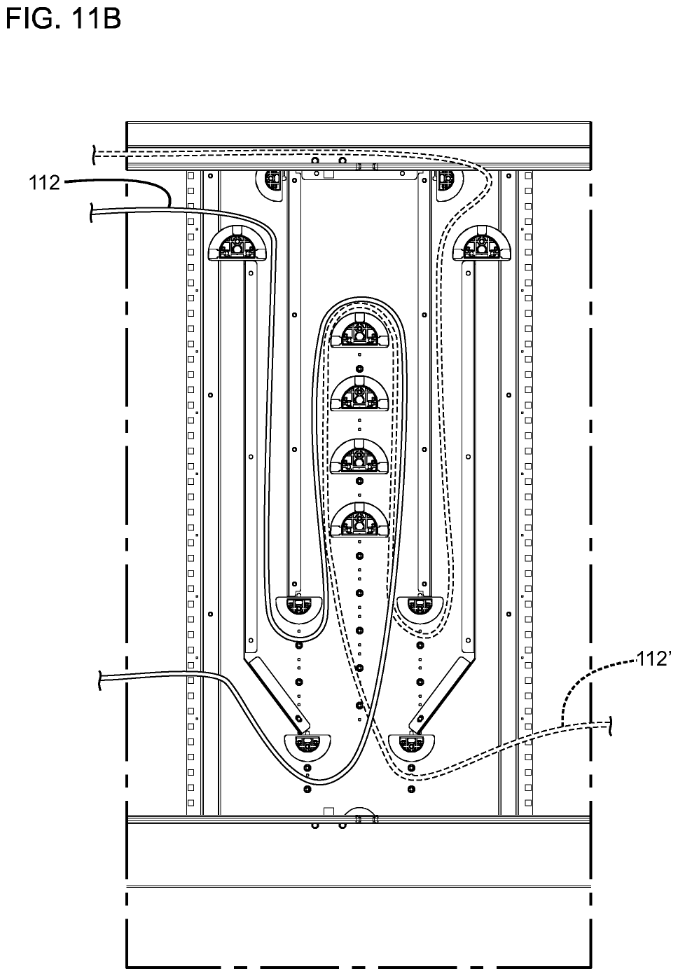

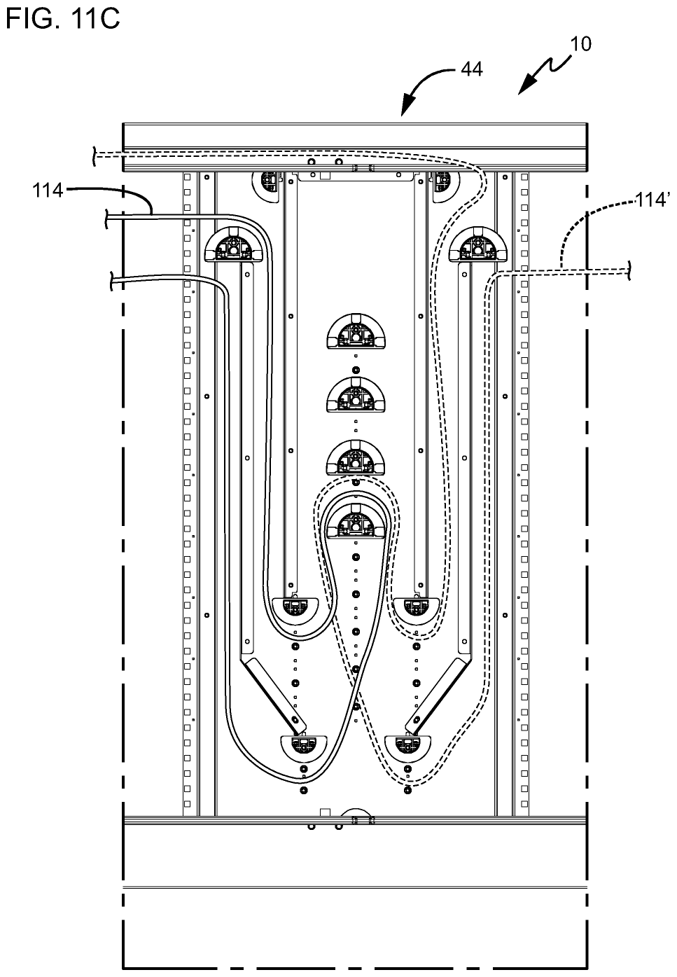

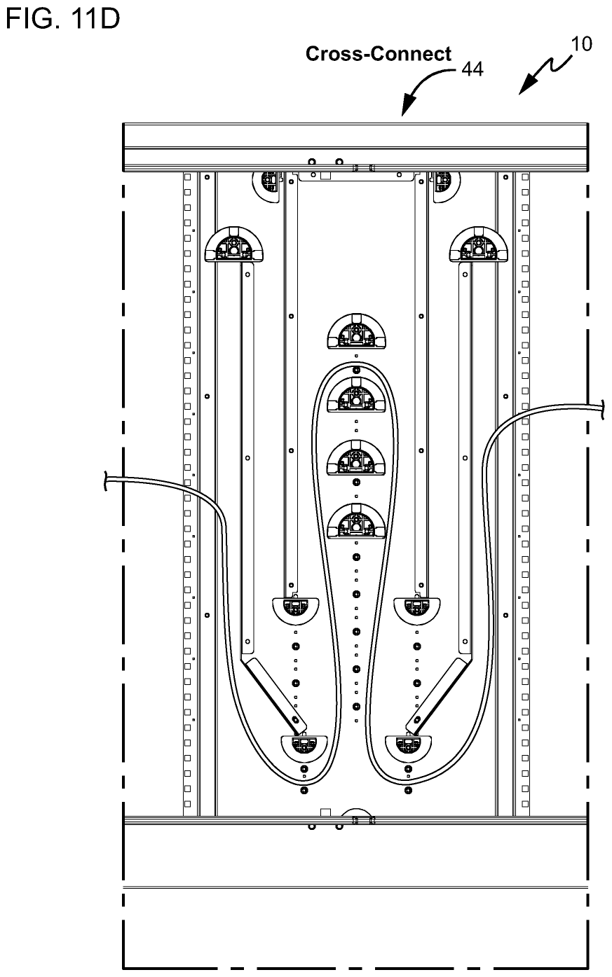

Referring now to FIGS. 1-11, a telecommunications equipment cabinet 10, or cabinet 10, is shown. Cabinet 10 holds equipment 100 for which various cables extend to and from for telecommunications connectivity. As will be described below in the example embodiments, equipment 100 has incoming and outgoing cables, as well as additional cables which connect different pieces of equipment 100 to each other, or to other telecommunications equipment, such as signal splitters. The preferred embodiments use fiber optic cables.

Cabinet 10 includes a top 12, a bottom 14, a left side 16, and a right side 18. In the example embodiments, cabinet 10 includes an accessible front 20, and a closed rear 22. Front 20 is accessible by movable doors 24 which are hingedly mounted about hinges 26 to respective left and right sides 16, 18.

Cabinet 10 includes an interior space 28 defined by a back wall 60, a sidewall 62, an opposite sidewall 64, a top cover 68, and a bottom wall 70.

Interior space 28 defines at least one equipment zone 40. In the example embodiment, interior space 28 also defines a splitter zone 42 positioned above equipment zone 40. A cable storage zone 44 is positioned adjacent to a side of splitter zone 42 and equipment zone 40.

Also shown in the example embodiment, equipment zone 40 is a first equipment zone 40. A second equipment zone 50 is positioned on an opposite side of interior space 28 opposite to the first equipment zone 40, and the splitter zone 42. Cable management or storage zone 44 is utilized by both equipment zones 40, 50 when equipment is present and cables need to be managed and stored.

In the FIGS. 1-11. equipment 100 is only positioned in equipment zone 40. Second equipment zone 50 is shown as empty, but available for equipment 100 as desired by the user. Such arrangement is an example of being able to add equipment at a later date from the initial setup of cabinet 10. Second equipment zone 50 includes a connector storage zone 52 for storing cables from the splitters 110 with connectorized ends for future deployment with added equipment 100. Connector storage zone 52 in one example holds the front ends of connectors terminated to cables, where the dust cap is still present.

In the present examples, the fiber optic connector types can be any of a variety of connector styles, including MPO multi-fiber connectors, single fiber optic SC connectors, single fiber optic LC connectors, or other fiber optic connectors.

Cabinet 10 includes a base 76 which spaces bottom wall 70 above the ground surface. Bottom wall 70 includes cable passages 78 for cables to enter and exit cabinet 10. Cable glands 80 assist with management and protection of cables passing through cable passages 78. Hand holes 82 can be provided to assist a user in providing cables to and from cabinet 10 through the ground.

Various devices within cabinet 10 are provided to provide for management of cables so as to improve accessibility to the equipment and the cables during initial setup, and during later maintenance or addition or removal of cables and/or equipment. Equipment 100 is mounted in equipment zone 40 and includes equipment panels 122, 124 including front pivotal and/or removable covers 128. Each of panels 122, 124 includes a termination panel 120 which includes a plurality of fiber optic adapters and fiber optic connectors connected to one another through the adapters positioned in the termination panels 120. The equipment panels 122, 124 can include various connectivity structures within the panels, including fiber splices, fiber breakouts, or other devices needed for telecommunications connectivity.

The equipment 100 includes panels of the type described and shown in U.S. Pat. Nos. 9,823,432; 10,025,055; US 2017/0276892; WO 2016/042017; US 2017/0276893; US 2018/0164524; US 2018/0231730; WO 2017/121778; WO 2017/125473, the disclosures of which are incorporated by reference. Other connectivity panels and equipment can be used.

Incoming cables 102 and outgoing cables 104 connect to equipment panels 122, 124 and enter cabinet 10 through glands 80 in bottom wall 70. These cables 102, 104 connect with fiber optic connectors to a rear side (the side not visible) of termination panels 120. Within cabinet 10, additional cables 112, 114 connect the front side of termination panel 120 to one another, or to other equipment located within cabinet 10.

As will be described below and shown in the example embodiment, a variety of panels, radius limiters, cable fixation plates, and cable channels are provided to manage the cabling within cabinet 10. The cable storage zone 44 includes a variety of cable channels including first vertical channel 141, second vertical channel 142, and third vertical channel 143. A horizontal channel 144 allows for cables to pass to vertical channel 145 and then equipment 100.

Within splitter zone 42, fiber optic splitters 110 are positioned. A staggered mounting plate 111 allows for multiple columns of splitters to be mounted in splitter zone 42. The staggered mounting plate has a stair-stepped arrangement from front to back so that the splitter cables do not interfere with one another. A horizontal cable passage 140 connects the splitter cables to first vertical channel 141. If second equipment zone 50 is utilized, a further vertical channel 147 is utilized within cable storage zone 44 for connection to channels 142, 143 through horizontal channel 144. As shown, splitter cables also pass through horizontal channel 146 to access second equipment zone 50.

Various cable radius limiters 160 are positioned within cabinet 10 for cable management and cable protection. Radius limiters 161, 162, 163, 164, 165, 166, 167, 168, 169, 170, 171, 172, 173 are in the form of half spools. Radius limiters 163-166 are selectable spools for positioning cable slack so that excess cable does not accumulate on bottom wall 70.

Various divider panels 180, 181, 182, 183, 184, 185 186 are provided to define the cable pathways for proper cable placement, and to help prevent cable placement in other areas that could lead to cable damage, or cable entanglements. Panel 180 forms a divider wall between channel 145 and channel 141. Panel 181 forms a divider wall between channels 141, 142. Panel 182 forms an upper divider wall to limit access to cable storage zone 44 from any direction except the bottom. Panel 183 forms a divider wall between channel 143 and channel 147. Panel 185 forms a divider wall between second equipment zone 50 and channel 147. Angled panels 184, 186 provide divider walls so that cables only exit or enter cable storage zone 44 at channel 141 at an upper portion of channel 141, or an upper portion of channel 147 or through horizontal channel 144 at a lower end of cable storage zone 44. Various fixation plates or tie-off plates 190 are provided within cabinet 10 for further management of the cables.

Equipment panel 122 can be connected to incoming cables 102. Input splitter cable pigtails 112 connect to panel 122 to feed all of splitters 110. Output splitter cable pigtails 114 connect to one of equipment panels 124 from the splitters 110. Equipment panels 124 are connected to outgoing cables 104.

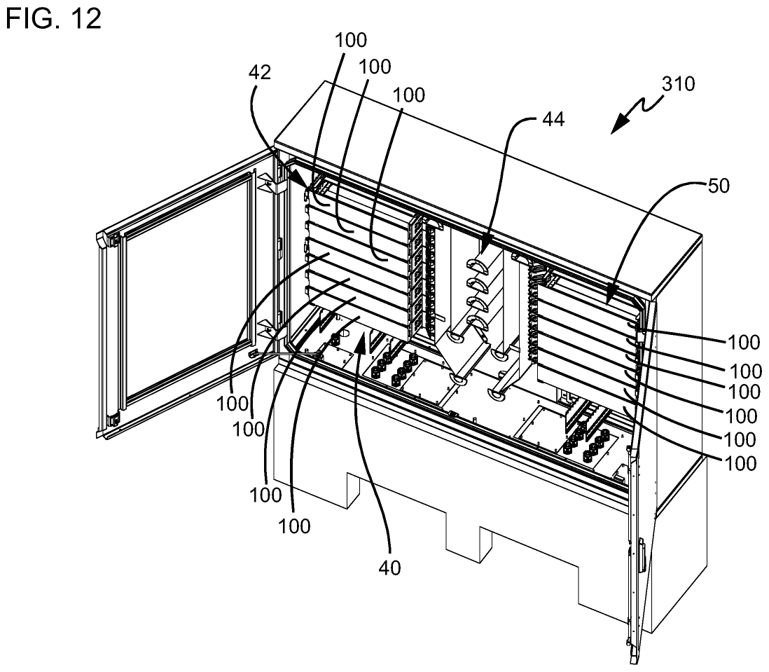

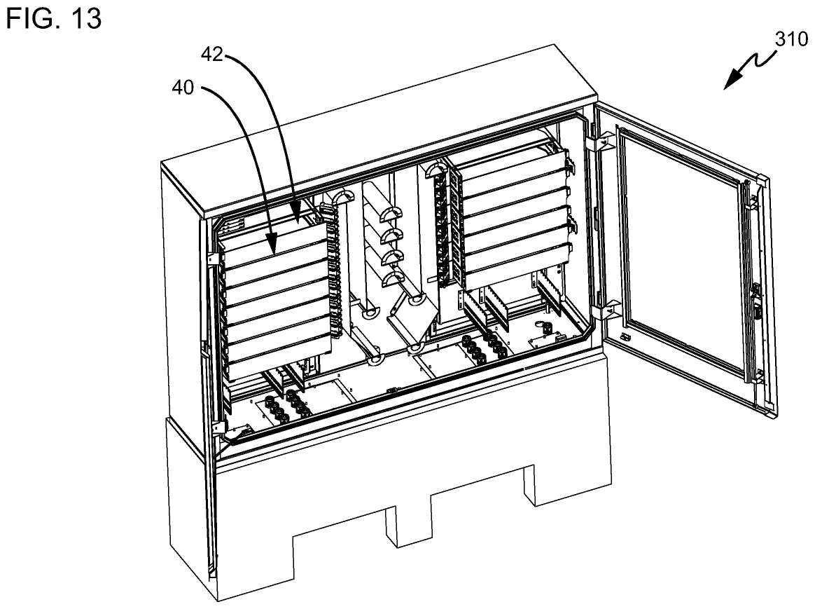

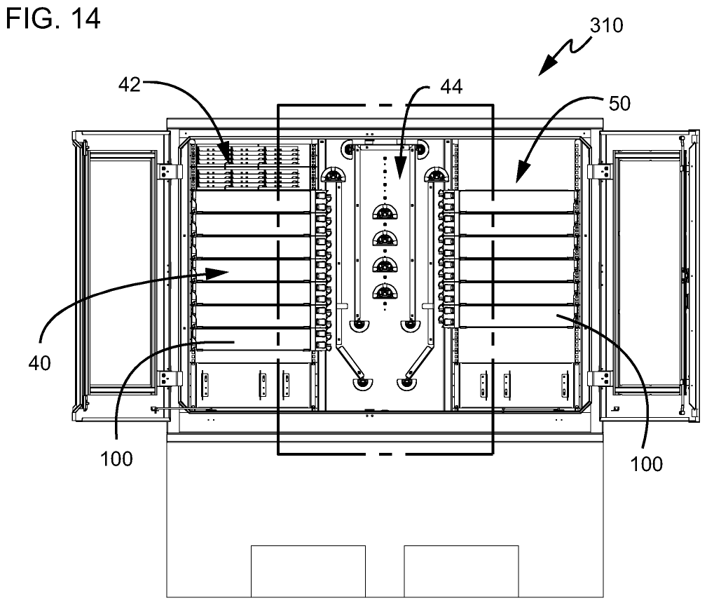

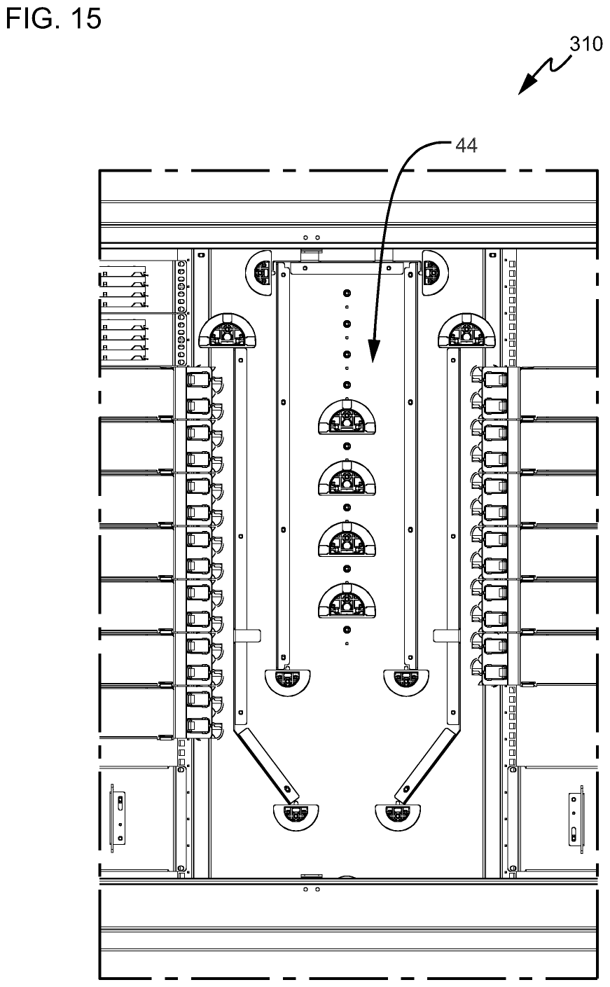

Referring now to FIGS. 12-15, a telecommunications equipment cabinet 310, or cabinet 310, is shown. Cabinet 310 is similar to cabinet 10. Cabinet 310 shows both equipment zones holding equipment 100 for which various cables run to and from for telecommunications connectivity.

1. A telecommunications equipment cabinet comprising: a cabinet enclosure defining an interior space, the interior space having an equipment zone, and a cable management or storage zone including a plurality of panels and radius limiters for guiding a technician for proper internal cable routing.

2. The telecommunications equipment cabinet of claim 1, further comprising a splitter zone for managing fiber optic splitters used in connection with the equipment positioned in the equipment zone, wherein cables extending to and from the splitters can be managed by the cable storage zone.

3. The telecommunications equipment cabinet of claim 1, further comprising the cabinet including two equipment zones spaced apart by the cable storage zone.

4. The telecommunications equipment cabinet of claim 1, wherein one of the equipment zones can also be combined in a vertical direction with a splitter zone for holding fiber optic splitters, wherein he storage zone manages the splitter pigtails.

5. The telecommunications equipment cabinet claim 1, wherein the one or more equipment zones can connected with patch cords in a cross-connect application.

6. The telecommunications equipment cabinet of claim 2, further comprising the cabinet including two equipment zones spaced apart by the cable storage zone.

7. The telecommunications equipment cabinet of claim 6, wherein one of the equipment zones can also be combined in a vertical direction with a splitter zone for holding fiber optic splitters, wherein he storage zone manages the splitter pigtails.

8. The telecommunications equipment cabinet of claim 7, wherein the one or more equipment zones can connected with patch cords in a cross-connect application.
